(19) United States
(12) Patent Application Publication
(10) Pub. No.: US 2026/0351447 A1
(43) Pub. Date: Nov. 5, 2026

(54) ULTRASONIC WELDING METHOD FOR NEW ENERGY PHOTOVOLTAIC WIRING HARNESS

(71) Applicant: SUNKEAN CABLE CO., LTD., Wuxi (CN)

(72) Inventors: Dongsheng Wang, Wuxi (CN); Mingming Xu, Yancheng (CN); Zhumiao Guo, Zhenjiang (CN); Qi Tang, Wuxi (CN); Jun Dai, Fuzhou (CN)

(21) Appl. No.: 19/713,558

(22) Filed: Jun. 18, 2026

(51) Int. Cl. H01B 13/012; B23K 20/10; B23K 101/38; H02S 40/36

(52) U.S. Cl. CPC H01B 13/01254; B23K 20/10; H02S 40/36; B23K 2101/38

(57) ABSTRACT

Provided is an ultrasonic welding method for new energy photovoltaic wiring harness, which includes fixing a main line on a bottom mold of an ultrasonic welding device; placing a branch line above the main line and adjusting a relative position between the branch line and the main line to form a cross-shaped or T-shaped overlap way between the branch line and the main line; limiting the branch line by a pushing block; activating an ultrasonic welding head, applying ultrasonic vibration and pressure to a cross-contact area between the main line and the branch line, and welding the main line and the branch line together. In the present disclosure, a vertical welding can directly lead out branch cables from a main line side without adding complex auxiliary structures, making internal wiring more compact and orderly, which is conducive to improving the space utilization of photovoltaic module backplates or junction boxes.

### TECHNICAL FIELD

The present disclosure relates to the field of ultrasonic welding technologies, and in particular, to an ultrasonic welding method for new energy photovoltaic wiring harness.

### BACKGROUND

Ultrasonic welding is a connection technology that uses high-frequency vibration waves to transmit to a surface of a to-be-welded workpiece, and under pressure, the workpiece surfaces rub against each other to form molecular layer fusion. In the field of new energy photovoltaics, wire harness connection is a key link in the transmission of electrical energy between internal busbars, outgoing lines, and external junction boxes of photovoltaic modules. Welding quality directly affects the conductivity, mechanical strength, and long-term reliability of photovoltaic systems.

At present, the application of ultrasonic welding in photovoltaic wire harness connection mainly adopts the following methods: firstly, parallel welding of wires, that is, welding two cables placed parallel to each other in the same direction; secondly, it is the direct welding of wires and terminals (such as metal terminals inside junction boxes); thirdly, there is welding with small or heteromorphosis angles within a certain range, such as overlapping cables at a certain inclination angle (not 90°). In the existing welding methods mentioned above, the connection direction of the two cables is basically limited to parallel or approximately parallel directions, and there is no technical solution for ultrasonic welding of the main and branch lines in a vertical cross form (such as cross-shaped or T-shaped).

The above-mentioned existing technologies have the following shortcomings: firstly, the parallel welding way extends the cables in a straight line after connection; in some photovoltaic modules where the wiring space is limited or vertical branch cables need to be led out from the main line, additional bending, adapter or winding operations are required, which increases the process complexity and space occupation; secondly, the heteromorphosis shape of joints welded at small, or heteromorphosis angles can easily lead to stress concentration when subjected to force, and it is difficult to achieve standardized and automated positioning; thirdly, the lack of vertical welding methods limits the flexible arrangement between the internal busbars and branch cables of photovoltaic modules, which is not conducive to improving the integration and reliability of photovoltaic modules.

Therefore, how to achieve vertical (cross-shaped or T-shaped) ultrasonic welding between the main and branch lines to simplify the wiring process, improve space utilization and joint reliability has become an urgent technical problem in this field; ultrasonic welding has a more stable contact resistance and can be more suitable for meeting high current resistance requirements.

### SUMMARY

The purpose of the present disclosure is to propose an ultrasonic welding method for new energy photovoltaic wiring harness so as to solve the above-mentioned problems.

In order to achieve the above objectives, the present disclosure adopts the following technical solution.

An ultrasonic welding method for new energy photovoltaic wiring harness, including:
fixing a main line on a bottom mold of an ultrasonic welding device;
placing a branch line above the main line and adjusting a relative position between the branch line and the main line to form a cross-shaped or T-shaped overlap way between the branch line and the main line;
limiting the branch line by a pushing block;
activating an ultrasonic welding head, applying ultrasonic vibration and pressure to a cross-contact area between the main line and the branch line, and welding the main line and the branch line together.

In some embodiments of the present disclosure, before placing the branch line above the main line, the branch line is first pre-welded and formed.

In some embodiments of the present disclosure, before fixing the main wire to the bottom mold, the main wire is pre-welded and formed.

In some embodiments of the present disclosure, both the main line and the branch line are original cables that have not been pre-welded before welding.

In some embodiments of the present disclosure, the main wire is placed in a lower position and limited by the bottom mold; the branch line is placed on an upper position and limited by the pushing block.

In some embodiments of the present disclosure, in the cross-shaped or T-shaped cross overlap way, a contact surface between the main line and the branch line is a pre-welding surface or an original cable surface.

In some embodiments of the present disclosure, the ultrasonic welding process is completed in a cross-shaped manner between the main line and the branch line, with the T-shape being perpendicular.

In summary, due to the adoption of the above technical solution, the beneficial effects of the present disclosure are as follows:
1. the present disclosure can directly lead out branch cables from a main line side through vertical welding without adding complex auxiliary structures, making internal wiring more compact and orderly, which is conducive to improving the space utilization rate inside the photovoltaic module backplane or junction box, adapting to the development trend of high-density integrated design, and the ultrasonic welding contact resistance is more stable, which can better meet the high current resistance requirements;
2. the present disclosure has two implementation modes, pre welding and direct lap welding, which can be flexibly selected according to different production conditions; during a welding process, the main line is placed in the bottom mold for limit, and the branch line is limited by the pushing block to ensure stable contact during cross-shaped or T-shaped overlap, facilitating effective transmission of ultrasonic energy; compared with traditional parallel welding, the joint formed by vertical welding bears different loads in the tensile direction of the main and branch lines, rendering it less prone to weld delamination caused by cable bending or pulling.

### BRIEF DESCRIPTION OF DRAWINGS

In the following description of exemplary embodiments in combination with the accompanying drawings, more details, features, and advantages of the present application are disclosed.

FIG. 1 is a welding process diagram provided by the present disclosure.

FIG. 2 is a method flowchart provided by the present disclosure.

### DESCRIPTION OF EMBODIMENTS

Below, several embodiments of the present application will be described in more detail with reference to the accompanying drawings, in order to enable those skilled in the art to implement the present application. This application may take many different forms and purposes and should not be limited to the embodiments described herein. Provide these embodiments to make the present application comprehensive and complete, and fully convey the scope of the present application to those skilled in the art. The embodiments described do not limit the scope of the present application.

Unless otherwise defined, all terms used in this specification (including technical and scientific terms) have the same meanings as those commonly understood by those skilled in the art to which the present application belongs. It will be further understood that terms such as those defined in commonly used dictionaries should be interpreted as having a meaning consistent with their meaning in the relevant field and/or the context of this specification, and will not be interpreted in an idealized or overly formal sense unless explicitly defined in this specification.

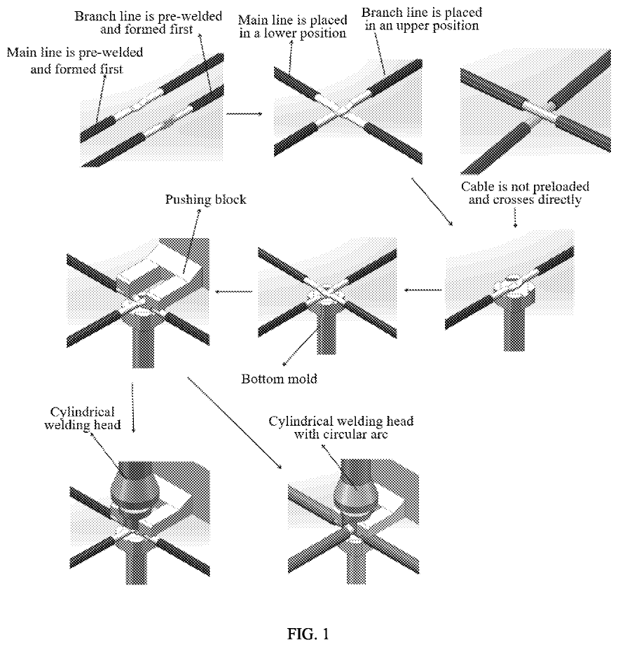

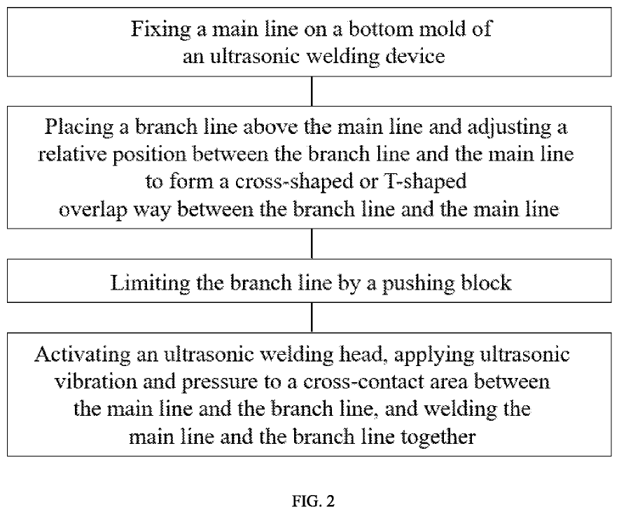

The specific implementation modes will be described in detail with reference to FIGS. 1 and 2.

In an implementation mode: perform vertical ultrasonic welding after pre welding and forming:
this embodiment provides an ultrasonic welding method for new energy photovoltaic wiring harness, which specifically includes the following steps:
main line pre-welding forming: taking the main line, placing it in a bottom mold of a welding device, and performing pre-welding under preset conditions, so that internal strands of the main line are fused together to form a pre-welding surface;
branch line pre-welding forming: taking the branch line and using the same welding parameters as the main line for pre-welding, forming a welding surface that matches the pre-welding surface of the main line;
clamping and positioning: placing the pre-welded main line into the bottom mold of the welding device, and the bottom mold is equipped with a limit groove that matches the shape of the main line, fixing the main line in place; placing the pre-welded branch line above the main line, adjusting a position of the branch line so that the branch line intersects with the main line in a cross-shaped or T-shaped cross manner, and the pre-welded surfaces of the two lines are completely in contact; then pushing in a pushing block, with a lower surface of the pushing block pressing down on the branch line to restrict its movement during a welding process;
final welding: activating an ultrasonic welding head and applying ultrasonic vibration to an overlap area between the main and branch lines, causing the pre-welded surfaces of the two to fuse and form a solid cross-shaped or T-shaped vertical welding joint.

In an implementation mode, another vertical ultrasonic welding method for new energy photovoltaic wire harnesses is provided, which does not require pre-welding treatment and specifically includes the following steps:
main line clamping: taking the main line without any pre-welding treatment and directly placing it into a bottom mold of an ultrasonic welding device; the bottom mold is equipped with V-shaped or arc-shaped limit slots to prevent the main line from rolling;
branch line positioning: taking the branch line that has not been pre-welded and placing it above the main line; adjusting a relative position so that the branch line intersects with the main line in a cross-shaped or T-shaped cross manner, and a contact surface between the two is an original cable surface (i.e. each strand of wire remains separated);
compression limit: pushing in a pushing block, a front end of the pushing block has an arc-shaped recess that matches the shape of the branch line; the pushing block pressing the branch line against the main line while maintaining a cross-shaped or T-shaped cross angle;
ultrasonic welding: activating an ultrasonic welding head and performing ultrasonic welding on an intersecting area; during a welding process, ultrasonic energy causes high-frequency friction, plastic deformation, and mutual fusion of the strands at the contact area between the main and branch lines, directly forming a vertically intersecting welding joint;
post processing: after welding is completed, pushing the pushing block back and removing the welded cable.

The above only describes certain exemplary embodiments of the present disclosure through explanation. It is beyond doubt that those skilled in the art can modify the described embodiments in various ways without departing from the spirit and scope of the present disclosure. Therefore, the above drawings and description are illustrative in nature and should not be construed as limiting the protection scope of the claims of the present disclosure.

It should be noted that in this specification, terms such as “first” and “second” are only used to distinguish one entity or operation from another, and do not necessarily require or imply any actual relationship or order between these entities or operations. Moreover, terms “including”, “having”, or any other variation thereof are intended to encompass non-exclusive inclusion, such that a process, method, item, or device that includes a series of elements includes not only those elements, but also other elements not explicitly listed, or elements inherent to such process, method, item, or device. Without further limitations, the element limited by the statement “including one...” does not exclude the existence of other identical elements in the process, method, item, or device that includes the element.

It should be understood that in various embodiments of the present application, the size of the sequence numbers of the above processes does not imply the order of execution. The order of execution of each process should be determined by its function and internal logic, and should not constitute any limitation on the implementation process of the embodiments of the present application.

Besides that, the functional units in various embodiments of the present application can be integrated into one processing unit, physically exist separately, or integrate two or more units into one unit.

The above is only a specific implementation mode of the present application, but the protection scope of the present application is not limited to this. Any skilled person familiar with the technical field can easily think of changes or replacements within the technical scope disclosed in the present application, which should be included in the protection scope of the present application. Therefore, the protection scope of the present application should be based on the protection scope of the claims.

What is claimed is:

1. An ultrasonic welding method for new energy photovoltaic wiring harness, comprising:
fixing a main line on a bottom mold of an ultrasonic welding device;
placing a branch line above the main line and adjusting a relative position between the branch line and the main line to form a cross-shaped or T-shaped overlap way between the branch line and the main line;
limiting the branch line by a pushing block;
activating an ultrasonic welding head, applying ultrasonic vibration and pressure to a cross-contact area between the main line and the branch line, and welding the main line and the branch line together.

2. The ultrasonic welding method for new energy photovoltaic wiring harness according to claim 1, wherein before placing the branch line above the main line, the branch line is first pre-welded and formed.

3. The ultrasonic welding method for new energy photovoltaic wiring harness according to claim 1, wherein before fixing the main wire to the bottom mold, the main wire is pre-welded and formed.

4. The ultrasonic welding method for new energy photovoltaic wiring harness according to claim 1, wherein both the main line and the branch line are original cables that have not been pre-welded before welding.

5. The ultrasonic welding method for new energy photovoltaic wiring harness according to claim 1, wherein the main wire is placed in a lower position and limited by the bottom mold; the branch line is placed in an upper position and limited by the pushing block.

6. The ultrasonic welding method for new energy photovoltaic wiring harness according to claim 1, wherein in the cross-shaped or T-shaped cross overlap way, a contact surface between the main line and the branch line is a pre-welding surface or an original cable surface.

7. The ultrasonic welding method for new energy photovoltaic wiring harness according to claim 1, wherein the ultrasonic welding process is completed in a cross perpendicular manner between the main line and the branch line, with a T-shape being perpendicular.
